(19) United States
(12) Patent Application Publication
(10) Pub. No.: US 2003/0233931 A1
(43) Pub. Date: Dec. 25, 2003

(54) Synchronized photo-pulse detonation (SPD)

(76) Inventor: Igor Z. Nemtsev, Bellevue, WA (US)

Correspondence Address: Ingrid T. Fuhriman, 13910 SE 23rd St., Bellevue, WA, 98005, US

(21) Appl. No.: 10/172,600

(22) Filed: Jun. 14, 2002

(51) Int. Cl. B64D 1/04; F41F 5/00

(52) U.S. Cl. 89/1.11

(57) ABSTRACT

The Synchronized Photo-pulse Detonation (SPD) method employs several fundamental techniques that are able to dramatically improve the kill-ratio of Laser Supported Detonation (LSD) of hostile targets, such as: missiles, aircraft, ships, and other land based targets, all the while reducing the chemical energy consumption and time needed per kill by thousands of times, thus making its deployment cost effective.

The SPD to use 2 (two) synchronized laser pulses to create a Laser Supported Detonation Wave (LSDW) in a mixture of target vapors and atmospheric air. The first pulse creates an ignition plasma spark (in a mixture of air and target vapors), while the second (higher powered) pulse serves to create and support a shock wave from the heated plasma. This shock wave heats the surrounding air layer (mixture of air and target vapors) so that it begins to absorb the laser beam and to create from itself the next plasma layer with the formation of a new shock wave.

The several thousands of tons of force generated by the LSDW are more than capable of destroying any object, such as an ICBM, aircraft, or build.

### BACKGROUND OF THE INVENTION

1. Field of the Invention

This invention is based on Dr. Nemtsev's research and knowledge of lasers in the former Soviet Union.

Two synchronized laser pulses are used to create a Laser-Supported Detonation Wave (LSD) in Atmospheric Air. The first pulse creates an ignition plasma spark. The second pulse served to create and support a shock wave from the plasma. This shock wave heats the surrounding layer so that it begins to absorb the laser beam and to create from itself the next plasma layer with a formation of new shock waves from that (next) plasma layer. This chain reaction continues along the laser beam as a detonation wave, powerful enough to destroy any hostile object.

2. Description of the Related Art

The United States of America Department of Defense (DoD) is in pursuit of developing laser-based weaponry in defense against hostile ballistic missiles, aircraft, and other vehicles of high threat. There are currently, two well known programs in pursuit of this concept; Airborne Laser (ABL) and Space-Based Laser (SBL), both models consists of focusing a laser beam on a missile (or object) in hopes to pop it and then explode the remaining fuel onboard. Please note: Patents for all Related Arts are considered “Classified.”

Billions of dollars have been poured into these two projects since the mid 1970s with mostly lackluster results. There are many drawbacks to this method, for example: 1) a missile could rotate around its axis to avoid being popped; 2) a thick movable screen in the area of incoming beam could shield the fuel tank; 3) since close range is required of this method, once the initial targeting beam is detected, optical and infrared jammers can be used to disrupt the targeting sensors and etc.

Since the end of the “Cold War”, we have learned that these Reagan era programs were actually designed to put-up a front to bankrupt the former Soviet Union, than to really produce anything operable.

### BRIEF SUMMARY OF THE INVENTION

The Synchronized Photo-pulse Detonation (SPD) method employs several fundamental techniques that are able to dramatically improve the kill-ratio of Laser Supported Detonation (LSD) of hostile targets, such as: missiles, aircraft, ships, and other land based targets, all the while reducing the chemical energy consumption and time needed per kill by thousands of times, thus making its deployment cost effective.

The SPD to use 2 (two) synchronized laser pulses to create a Laser Supported Detonation Wave (LSDW) in a mixture of target vapors and atmospheric air. The first pulse creates an ignition plasma spark (in a mixture of air and target vapors), while the second (higher powered) pulse serves to create and support a shock wave from the heated plasma. This shock wave heats the surrounding air layer (mixture of air and target vapors) so that it begins to absorb the laser beam and to create from itself the next plasma layer with the formation of a new shock wave.

The length of absorption of a laser beam in plasma near detonation threshold must equal the beam radius thus, the temperature T_{LSD} in the Laser Supported Detonation Wave (LSDW) near the threshold is not more than 20,000° K depends on the ionization potentials of the target material's atoms. Since the heated plasma does not have time to expand in the LSDW, the pressure P_{LSD} in LSD is:

P_{LSD}>k*P_{ATMOSPHER}*T_{LSD}/T_{ATMOSPHER}>70*k*P_{ATMOSPHER},

Where k varies from 2.1 to 15 and even more depending on the atoms of the target material present in the dissociated air. So, P_{LSD} varies from 150 to 1000 atmospheres. If the laser beam focuses in the spot of diameter D or on the area S, the disturbance force F will be as follows:

| | |
|---|---|
| If D = 10 cm, then: | F = P_{LSD} * D² = from 15 to 100 Tons |
| If D = 1 m, then: | F = P_{LSD} * D² = from 1,500 to 10,000 Tons |
| If S = 1 m * 100 m, then: | F = P_{LSD} * D² = from 150,000 to |
| | 1,000,000 Tons |

Several thousands of tons is more than enough to “shoot down” a hostile missile. If this force is not sufficient, this impulse force can be increased simply by increasing the vapor density (target material intensive vaporization). It is also critical to point out that the SPD's method is not restricted to distance, due to the fact that no continuing sharp focusing of the laser beam to the same area of the missile is required, the shot takes only 1 (one) millisecond, as compared to the several seconds by the existing method (See FIG. 1).

### DETAILED DESCRIPTION OF THE INVENTION

1. Detonation Methods

Spin Method: When the LSDW is focused on a large area near either end of a missile or object; it creates a large value of disturbance force on the object. This momentum can cause a spin and downward fall of the object, derailing it from its original course or trajectory (See FIG. 2).

Overload Method: The LSDW can also be focused on the full surface of a missile, aircraft, helicopter, and any other objects. By doing so, this object will be exposed to overload of many thousands of G-forces (Gs) or even millions of Gs, if the first ignition beam creates a high enough pressure of vapors near the object. This overload will cause destruction to the object's infrastructure and the ignition of any remaining fuel (See FIG. 3).

The size and weight of a laser system can be decreased by a hundred times without any decrease to the overload effect by decreasing the laser pulse duration to 10 nanoseconds.

The initial vapors can be created at the top of an object by a more durable first pulse. Streamlined air would press this vapor layer to the object. So, the duration of the first laser pulse has to be equal to the missile's length divided by the object's speed, which is not more than 1 millisecond. The spot of focusing of this first laser beam has to be large enough in order to quickly provide enough vapors. Thus, going after vapors 1 mm inside the object is optimal.

The second (10-nanosecond) pulse creates LSDW in the vapor layer 1 (one) millisecond after the evaporation process begins. Therefore, if the LSD pressure is not enough to “shoot down” the missile, the power of the first laser has to be increased to evaporate and detonate more material per millisecond (but still going for vapors not more than 1 mm inside the).

2. Threshold of Laser Supported Detonation Wave

A Laser Supported Detonation Wave (LSDW) is used in this invention rather than that of a Laser Supported Combustion Wave (LSCW). The difference between LSDW and LSCW is the velocity at which the combustion region travels. In steady state, the LSDW travels at supersonic speeds supporting a shock wave, while LSCW travels at subsonic speeds. The major difference between LSDW and LSCW refers to the thresholds of wave velocity. The threshold velocity for combustion wave is zero. LSCW cannot provide a pressure on targets while LSDW can.

Optimal Laser Supported Detonation Wave (LSDW) characteristics are determined by the following equations:

1) mass conservation:

ρu=ρ₀D

2) momentum conservation:

P+ρu²=P₀+ρ₀D²

3) energy conservation:

E+P/ρ+u²/2=E₀+P₀/ρ₀+D²/2

4) complete laser energy absorption at Chapman Jouguet Point:

E+P/ρ+u²/2=E₀+P₀/ρ₀+D²/2+I₀/(ρ₀D)

Where ρ is density, u is internal velocity, E is internal energy, D is wave velocity and P is pressure in Laser Supported Detonation Wave. The equation of state transformation from gaseous state to plasma state completes the set of equations.

If the threshold laser intensity is not more than 10⁸Wt/cm², then the speed of LASDW at threshold is not more than 2*10⁵ cm/sec (depending on the atomic mass of evaporated materials from missile or other target). So, for 1 microsecond (theoretically 10 nanoseconds is enough for LSDW formation) LSDW penetrates only several mm inside a missile, pushing it with maximum effectiveness. The energy E needed to support this LSDW by a microsecond laser impulse is:

E<10⁸ Wt/cm²*10⁻⁶sec=100 Joules/cm²

To support LSD (with beam diameter at a missile surface 100 cm²) only 10,000 Joules during microsecond impulse or 100 Joules during 10 nsec impulse is needed.

A pulsed-periodical chemical laser based on the chain reaction of fluorine and hydrogen can generate more than 5,000 Joules during a 1 microsecond pulse with only 0.04 m³ active volume of HF.

The optimal proportions of chemicals used in SPD to achieve LSDW are as follows with a variance of ±30, pending the environment of the event:

F₂=4.00 or 38.46% by Volume

H₂=1.00 or 09.62% by Volume

O₂=0.40 or 03.85% by Volume

SF₆=5.00 or 48.08% by Volume

The proportions of the mixture, composed of fluorine and hydrogen with the diluent's gas SF₆ are the most chemically stable. Moreover, the specific amount of SF₆ makes the entire mixture inert to all other detonation or initiation methods (such as power light source) except that of an electrical discharge or electron accelerator, making the chemical mixture safe to handle under most battle conditions.

The firing process of SPD can be initiated by electron beams, with optimal repetition rate of pulses between 1-5 Hz, depending on the size of target and event environment. If a single laser impulse is not enough to destroy a target (a missile in this case) but only to cause its vibration, such a repetition gives us the opportunity to repeat laser impulses resonantly to the frequency of this vibration until complete destruction of any object.

As a comparison, the power of the chemical oxygen iodine megawatt laser (COIL) that is applied by the existing method in ABL, with duration of several seconds to evaporate a minimum volume of a metal consumes millions Joules/cm², that is thousands times more than the what the invention will use.

The contact time between a missile and a beam generated by the SPD is one millisecond at a time or less to hit this object instead of several seconds or even minutes of contact time needed by the existing method to drill a deep hole in a fuel tank for “popping”. Several seconds, would likely be enough time for a missile to defend itself (by a screen, by rotation, etc). In this case, the needed time “to ignite the remaining fuel” would be increased hundred times additionally. Therefore, the required power consumption for the existing laser method would be billions of Joules, it's millions of times more than what this invention needs.

It is important to point out that the LSDW generated by the SPD can be accomplished not only with chemical lasers but also by any other pulse lasers: for example, solid-state YAG-Nd lasers, CO₂-lasers, and etc.

3. Electron Beam Accelerator

An electron beam methods can be used to initiate the chemical reaction in a laser volume. When operating the SPD, the electron beam accelerator with the following parameters can be used:

1) Maximum energy of the electrons:

500 keV

2) Maximum energy of the electron beam behind an anode foil:

6 kJ

3) Maximum current density on the anode:

25 A/cm

4) Beam cross-section on the anode:

200 mm×600 mm

5) Efficiency of the accelerator (ratio of electron beam energy to the energy stored in capacitors of a pulsed generator):

>60%

6) Pulse duration:

1 microsecond

7) Resource of operation (without changing the anode foil):

300 few hundred shots

8) Repetition rate of pulses:

1-5 Hz

The electron accelerator could comprise of 3 units: a high-voltage unit, a charging unit and a programmable console, with the following parameters: 1) The high-voltage unit (a generator, a pulsed transformer and a sealed accelerating tube) should be located inside a sealed metallic cylinder casing filled with capacitor oil. 2) The capacitors, powered through charging inductances with a pulse transformer, whose primary winding=2 μF capacitance at 10 kV voltages. The secondary winding need to achieve 100 kV at 4 microsecond charging pulse. The capacitance needs to be 70 pF in a discharge. High-pressure gas-filled gaps serve for current communication. The generator is loaded to the accelerating tube, which is a vacuum diode with a cold cathode. The tube cathode needs to be manufactured of tantalum foil blades, providing a uniform density of electrons incident on the anode. The anode in the electron-beam tube needs to be made of thin (25-50 micrometers) titanium foils. This accelerator is equipped with a set of measuring devices.

The electron accelerator initiation produces is capable of producing 5 times more specific output energy as compared to that of an electrical discharge initiation. For example, if two accelerators, which emitted two contrary beams with (20*60) sq cm cross-section and the maximum energy 400 keV, initiate the chemical reaction, the average specific energy can reach 130 Joules/liter. Indeed, active volume 0.045 sq. m gives 5,900 Joules during microsecond pulse. It's 5.9*10⁹ Wt/cm², which is enough to support beam detonation of 10 cm in diameter, and create a big overload of targeted body.

4. Laser Set-Up

With most chemical lasers, the initiation of large volumes of chemicals is achieved by propagating an electron beam along the laser's optical axis. A strong magnetic field is used to contain the electron beam; unfortunately, this application is nearly as energy consuming as producing the electron beam itself, reducing the efficiency of the laser.

The SPD could use a cross-section electron beam or any other types of electron beam to initiate the chemical volume, as long as the electrons move perpendicular to the optical axis of the laser.

When a cross-section electron beam or any other electron beam sharing similar characteristics is used, it makes it possible to dispense an extra magnetic field, which ensures a high overall efficiency of the laser, and arrange the mixture flow through an initiated volume, which is essential for periodic operation of the laser. The matter here is that the initiation and chemical processes causes irreversible changes to the mixture itself and, for the next chemical laser pulse generation to occur, the laser cavity must be discharged of the waste substances and be filled with fresh mixture in the time frame between two consecutive initiating pulses. (See FIG. 4, it depicts the scheme of the chemical laser pulse-periodical cannon with standard mixture flow system)

5. Parameter Required of Chemical DF & HF Lasers

The need for optimal atmosphere transparency makes HF lasers the best choice for use in a laser cannon.

The specific output energy from the active medium of DF laser is much lower in comparison with HF laser in spite of, that during the chain reaction D₂(H₂)+F₂ the same energy of chemical interaction is consumed on excitation of vibration-rotational level of DF and HF molecules. The cause of lower energy characteristic of pulsed chemical DF lasers in comparison with HF lasers is the strong influence of CO₂ impurity within the resonator on the energy and spectral characteristics of the DF laser.

The influence of CO₂ impurity on the output characteristics of the DF laser is determined by 2 reasons: 1) the high values of relaxation rate constants of the excited DF* molecules by CO₂ molecules and 2) high values of the CO₂ absorption coefficients in the wavelength range from 4.2 up to 4.3 μm that is inside irradiation wavelengths of DF laser. The existing technology permits to produce fluorine with the CO₂ impurity concentrations up to 0.1%. Such a high concentration of the CO₂ impurity within fluorine is a reason of the lower and unstable energy characteristics of the DF laser.

The parameters of CO₂ impurity in the fluorine used as an oxidizer in the HF- and DF-lasers mediums are such: the CO₂ concentration in laser medium should not exceed 0.4 for the HF laser medium and 0.005% in a DF laser medium.

6. Synchronized Photo-Pulse Detonation (SPD) Cannon Applications

The Synchronized Photo-pulse Detonation (SPD) method is such a versatile technology, not only is it capable of improving the kill-ratio and the time needed for Laser Supported Detonation (LSD) of hostile targets, it can also be deployed on any current and future (planned) firing platforms and in the following areas & applications:

A. Space (satellites, stations, & vehicles) (See FIG. 5)

B. Abovewater (any water vehicles or ships) (See FIG. 6)

C. Underwater (any under vehicles or platforms) (See FIG. 7)

D. Ground (any ground vehicles or platforms (See FIG. 8)

E. Air (any air Vehicles) (See FIG. 9)

F. Man-portable devices (See FIG. 10)

A. Space (Satellites, Space Stations, Space Vehicles)

The Synchronized Photo-Pulse Detonation (SPD) system can be easily integrated into the planned Space Based Laser (SBL) system.

Unlike the current laser system, which requires sharp focusing of the laser beam on the target and does not travel well through the atmosphere, the SPD system is able to generate an enormous amount of force via its shock wave (Laser Supported Detonation Wave or LSDW) and is capable of engaging atmospheric targets, such as enemy fighters.

The Advantages of a Space SPD System are as follows:

Technology & capability inline with the planned SBL system

Does not require sharp focusing of laser beam

Tremendous force generated by laser shock wave

Can engage targets thousands of mile away

Capable of engaging lower atmospheric targets: enemy planes

More cost efficient than current laser system

Adjustable beam control, capable of weeding out the decoys

B. Ships (Surface Warships)

The Synchronized Photo-Pulse Detonation (SPD) system, the same system built for the Space Based Laser (SBL) can be easily converted for Naval ship use in the Sea Based Midcourse (SBM) & Sea-based Terminal (SBT) element of the Ballistic Missile Defense System (BMDS).

The SPD does not require the sharp focusing of the laser beam; it is capable of engaging both atmospheric and outer atmospheric targets from the sea level. Unlike the interceptor missiles that represent the current system, SPD laser firing is not track-able by enemy radar or satellite systems. The kill is instantaneous, rather than tens of minutes or even hours (preventing the Multiple Reentry Vehicles (MRVs) from deploying decoys)

The Advantages of Naval SPD System are as follows:

Can use the same hardware as the SPD SBL system—converts easily

Multiuse system—Able to engaging ICBMs, air & water crafts/ships

Laser is not track-able by radar or satellite, the kill is instantaneous

Much more cost efficient than the current million dollar anti-missile system

Requires less space onboard, and is inline with DDX design criteria

C. Submarines (Underwater Warships)

The Synchronized Photo-Pulse Detonation (SPD) system the same system built for the Space Based Laser (SBL) and the Sea Based Midcourse (SBM) & Sea-based Terminal (SBT) element of the Ballistic Missile Defense System (BMDS) can be easily modified for use under water.

The underwater version of the SPD, could use a specific wavelength of 1,06 μm, or any other wavelength which is transparent in both the air and water medium, can be deployed on any underwater or surface firing platform against both surface and underwater targets. The underwater SPD system fits well into both the anti-shipping and anti-submarine roll or any other roll by extending the capabilities of any attack submarine, frigate, or destroyer. Unlike torpedoes, which can be avoided by decoys, the SPD event (or firing) under water is instantaneous, once a firing solution is reached; there is no escape for the target. The SPD effect is similar to that of an underwater shockwave from an explosion, but more direct and focused towards a specific target.

The Advantages of the land based SPD system are as follows:

Can use the same hardware as the SPD SBL & SBM systems

Multiuse system—fitted aboard both submarines and ships or under water firing platforms.

The SPD shock wave under water is instantaneous and unavoidable by deploying decoys

Less per firing costs as compared to that of a torpedo

D. Ground Vehicles

The Synchronized Photo-Pulse Detonation (SPD) system, the same system converted for (SBM) can be easily converted for ground vehicles use in the Terminal Defense Segment (TDS) of the Ballistic Missile Defense System (BMDS) or be used against any other ground or air target.

The land based SPD can be mounted on any platform, tracked or wheeled platforms such as the; M113, LAV-25, Bradley, or the MLRS platform (See FIG. 8). The SPD system fits well into the Theater High Altitude Area Defense (THAAD) and the Medium Extended Air Defense System (MEADS) by extending the range and capabilities of systems such as the Patriot Advanced Capability-3 and PAC-3 systems.

The Advantages of the land based SPD system are as follows:

Converts or retrofits easily from the Naval SPD system

Mobile and light weight

Multiuse system—Able to engage missiles, land and air vehicles, personnel

Laser is not track-able by radar or satellite, the event is instantaneous

Much more cost efficient than the current million dollar PAC-3 system

Can be deployed as an automated sentry system and set-up perimeter

E. Air Vehicles

The Synchronized Photo-Pulse Detonation (SPD) system, the same system built for the Space Based Laser (SBL) can be easily converted for use with the Air Borne Laser (ABL) system, part of the Boost Defense Segment of the Ballistic Missile Defense System (BMDS). or any other system.

The SPD system made for space and land use, it can be fitted inside an air vehicle as small as a GD Golfstream aircraft with ease, unlike the current system, which requires a Boeing 747 to carry everything. Again, since the SPD does not require sharp focusing and travels well in the atmosphere, the SPD ABL system (aircraft) does not need to travel deep within enemy territory to shoot down missiles in their boost phase.

It is another object, advantage, and feature of the invention that the Advantages of the airborne SPD System are as follows:

Converts easily from the Space or Land SPD system

Small enough to fit inside a GD Gulfstream or comparable air vehicle

Multiuse system—Able to engage any objects on land, air or space.

Laser firing not track-able by radar, no time for decoys to deploy

Much more cost efficient than current ABL concept

F. Man-Portable Devices

It is another object, advantage, and feature of the invention that the SPD laser system can be miniaturized to be made man-portable. The Compact Chemical Laser Cannon brings the power of Star Wars technology to the field. Providing heavy punch capabilities to the Special Operation Forces (SOF) at a relative low cost.

It is another object, advantage, and feature of the invention that the Advantages of the Man-portable SPD System are as follows:

Portable & lightweight (comparable to the Armbrust & Dragon anti-tank systems)

Capable of emitting/firing 1000-4000+ Joules of energy per shot

Synchronized Photo-pulse Detonation Wave (SPDW) generated by cannon provides up to 10+ tons of force

Beam radius control system allows the user to adjust the area of detonation

Rugged and durable—unlike power laser systems

### BRIEF DESCRIPTION OF THE SEVERAL VIEWS OF THE DRAWING

FIG. 1: Compares the difference between the current SBL & ABL kill method (Focusing the Laser to a specific part of the missile to drill a hole, in order to ignite onboard fuel) and that of the SPD, which is an impulse shockwave not restricted by distance.

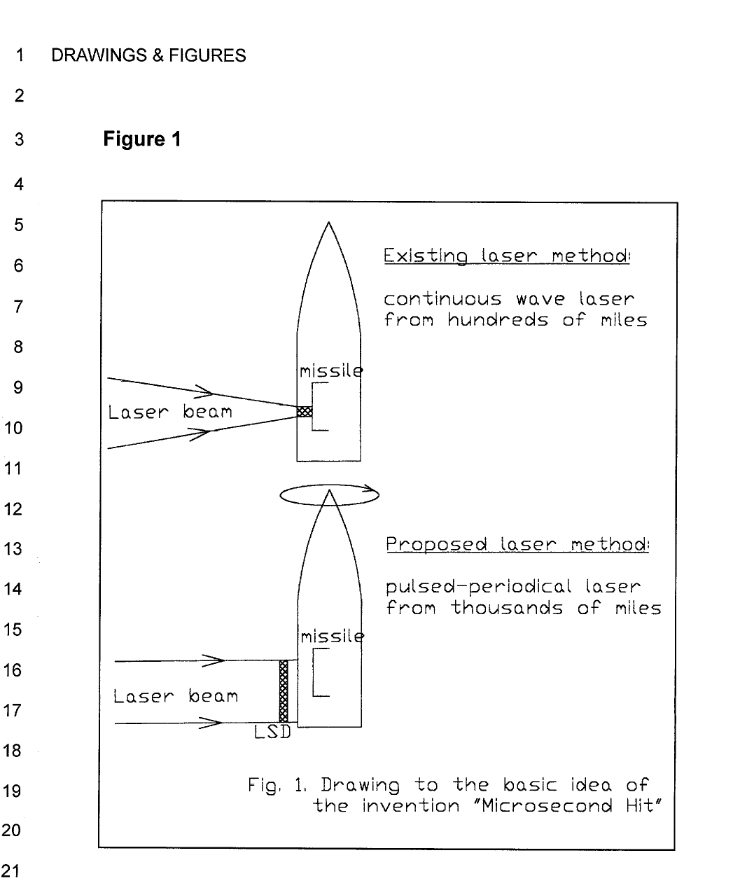

FIG. 2: Depicts the SPD “Spin Method”, When the LSDW is focused on a large area near either end of a missile or object; it creates a large value of disturbance force on the object. This momentum can cause a spin and downward fall of the object, derailing it from its original course or trajectory.

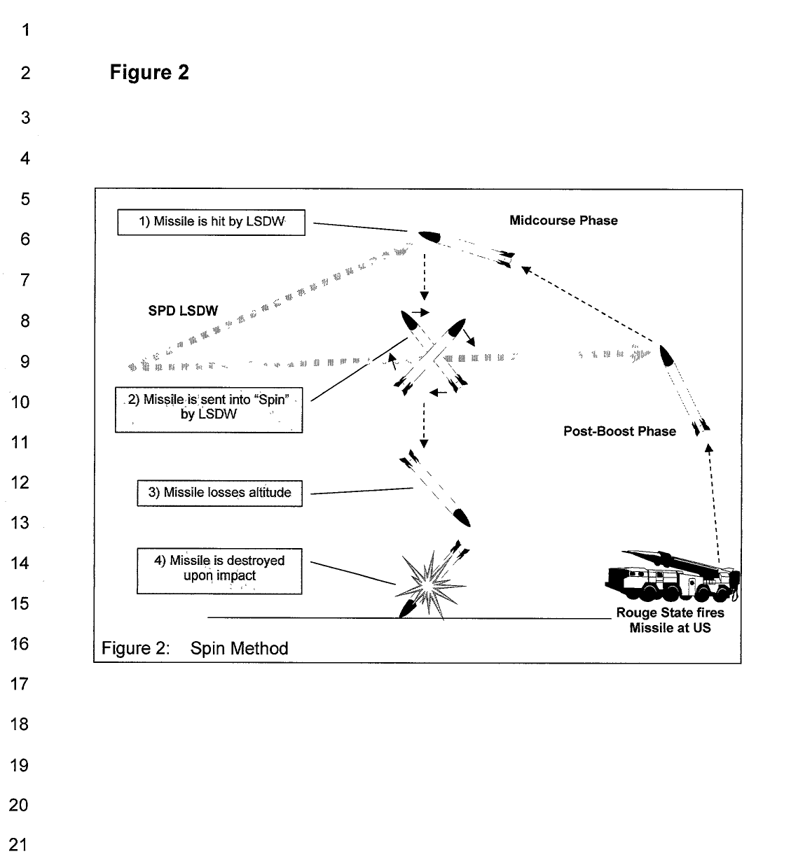

FIG. 3: Depicts the SPD “Overload Method”. The LSDW is focused on the full surface of a missile, aircraft, helicopter, and any other objects. By doing so, this object will be exposed to overload of many thousands of G-forces (Gs) or even millions of Gs, if the first ignition beam creates a high enough pressure of vapors near the object. This overload will cause destruction to the object's infrastructure and the ignition of any remaining fuel.

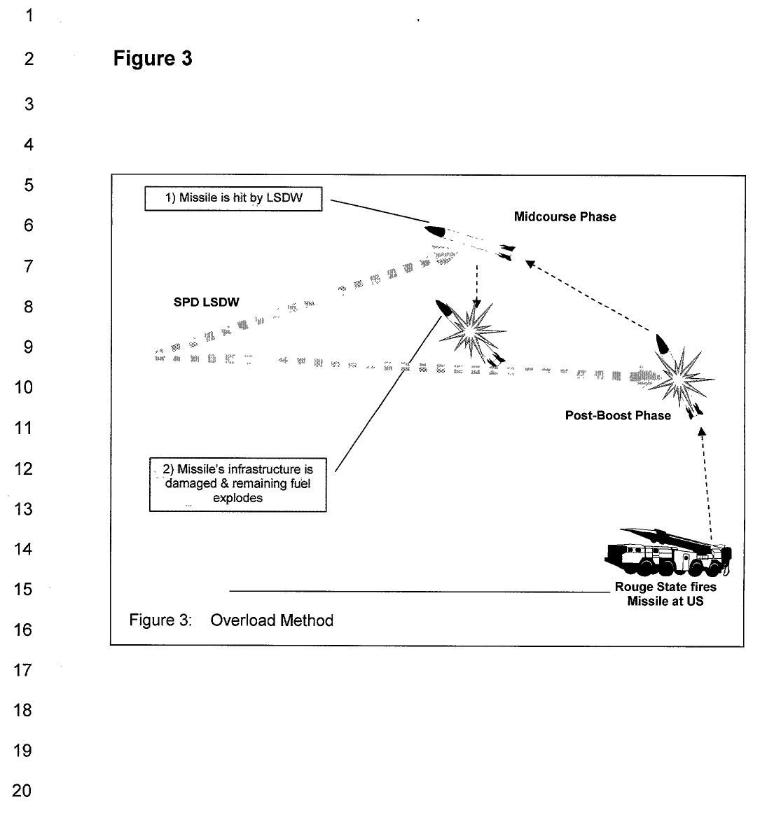

FIG. 4: Depicts the scheme of the chemical laser pulse-periodical cannon.

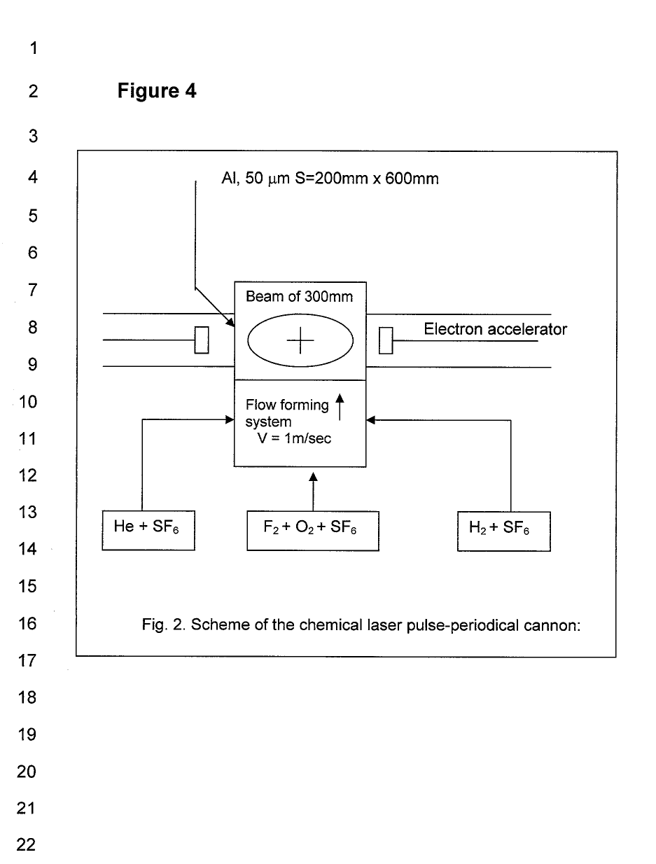

FIG. 5: Depicts the different applications of SPD in Space. Unlike the current laser system, which requires sharp focusing of the laser beam on the target and does not travel well through the atmosphere, the SPD system is able to generate an enormous amount of force via its shock wave (Laser Supported Detonation Wave or LSDW) and is capable of engaging atmospheric targets, such as enemy fighters.

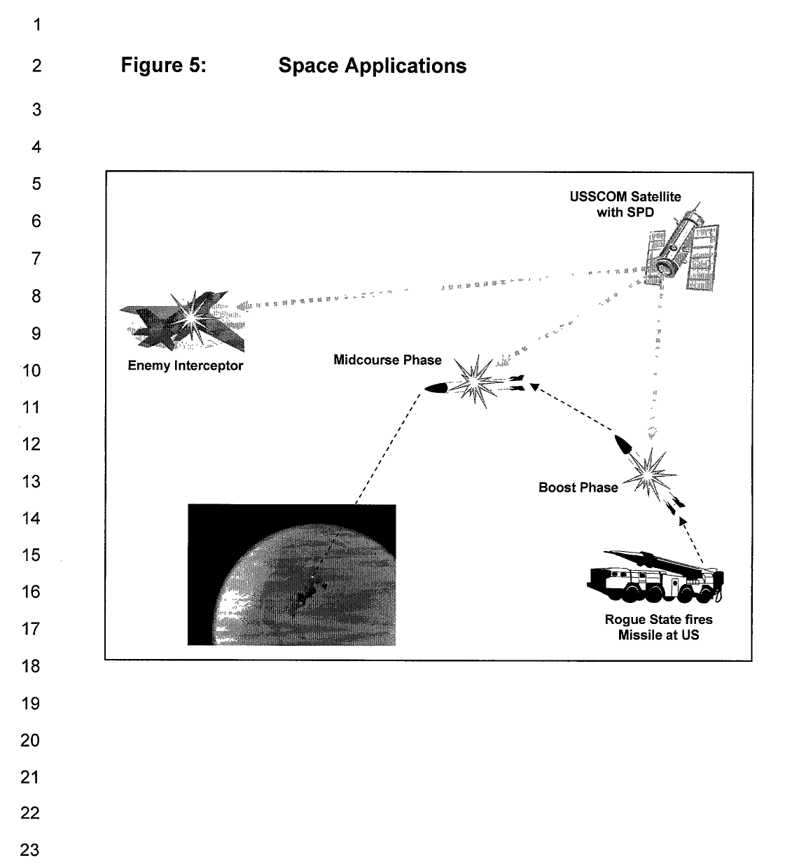

FIG. 6: Depicts the different applications of SPD on water vehicles, such as ships. The SPD does not require the sharp focusing of the laser beam; it is capable of engaging both atmospheric and outer atmospheric targets from the sea level. Unlike the interceptor missiles that represent the current system, SPD laser firing is not track-able by enemy radar or satellite systems. The kill is instantaneous, rather than tens of minutes or even hours (preventing the Multiple Reentry Vehicles (MRVs) from deploying decoys). It is also capable of engaging any other airborne vehicles.

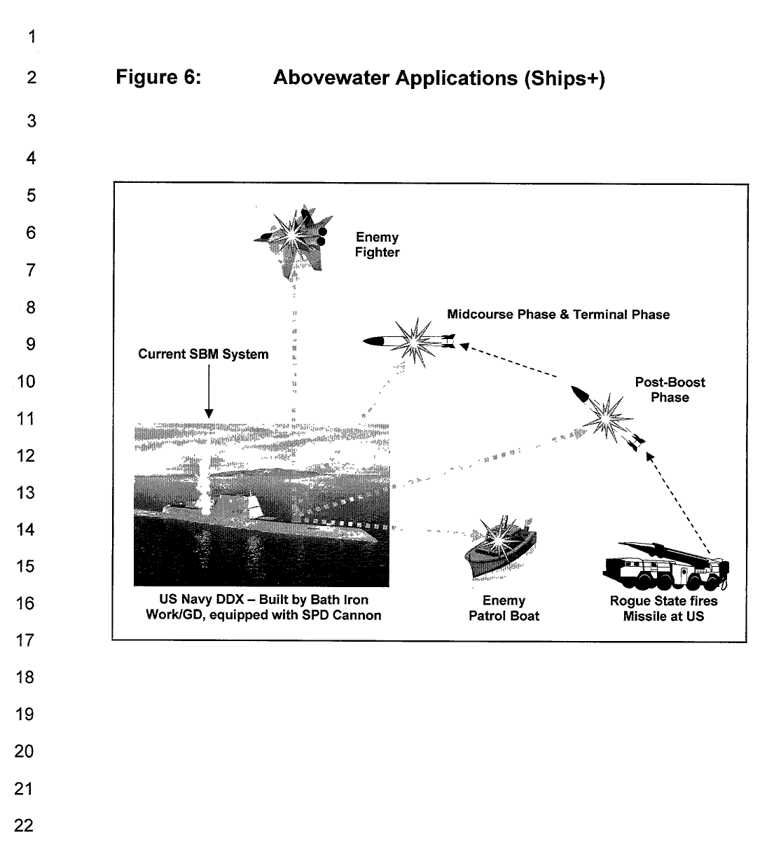

FIG. 7: Depicts the different applications of SPD on underwater vehicles, such as submarines. The underwater SPD system fits well into both the anti-shipping and anti-submarine roll and any other roll by extending the capabilities of any attack submarine, frigate, or destroyer. Unlike torpedoes, which can be avoided by decoys, the SPD event (or firing) under water is instantaneous, once a firing solution is reached; there is no escape for the target. The SPD effect is similar to that of an underwater shockwave from an explosion, but more direct and focused towards a specific target.

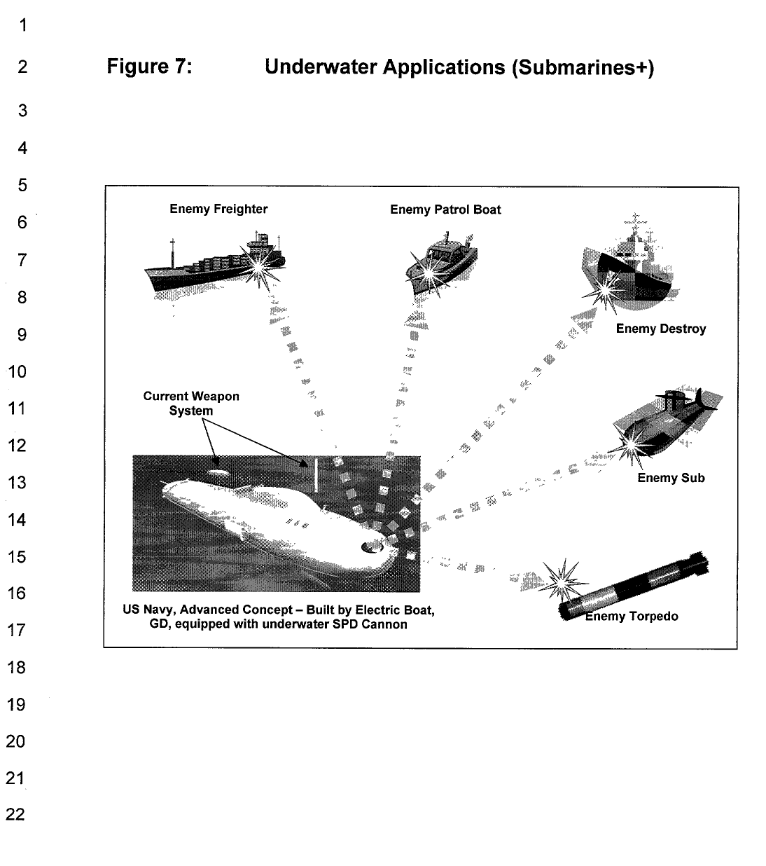

FIG. 8: Depicts the different applications of SPD on ground vehicles or platforms. The land based SPD can be mounted on any platform, tracked or wheeled platforms such as the; M113, LAV-25, Bradley, or the MLRS platform (See Figure). The SPD system fits well into the Theater High Altitude Area Defense (THAAD) and the Medium Extended Air Defense System (MEADS) by extending the range and capabilities of systems such as the Patriot Advanced Capability-3 and PAC-3 systems.

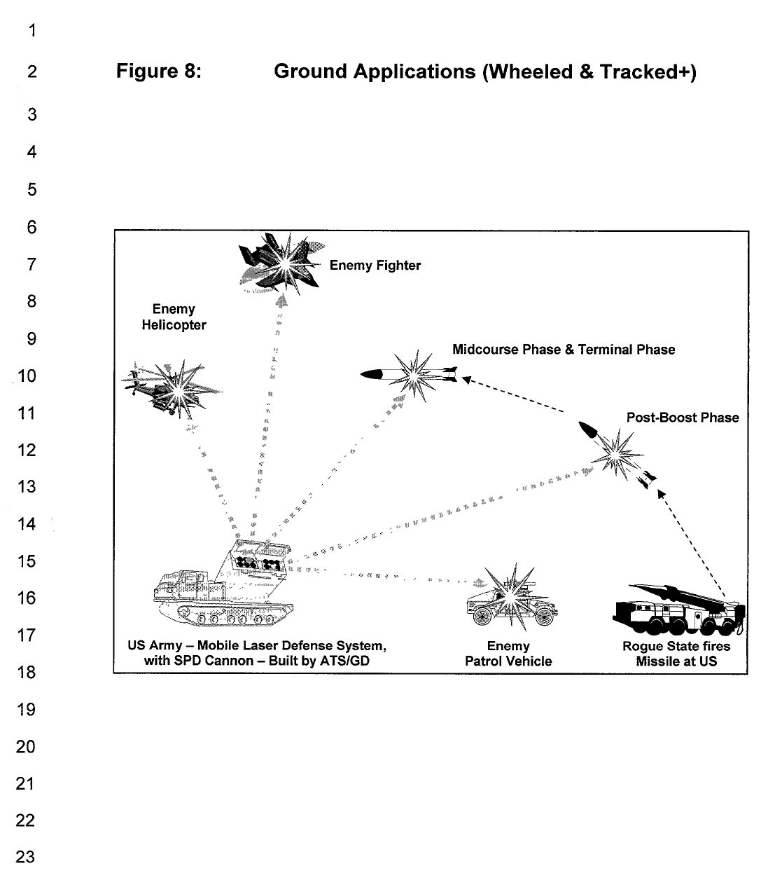

FIG. 9: Depicts the different applications of SPD aboard air vehicles, such as the GD Gulfstream. The SPD system made for space and land use, it can be fitted inside an air vehicle as small as a GD Golfstream aircraft with ease, unlike the current system, which requires a Boeing 747 to carry everything. Again, since the SPD does not require sharp focusing and travels well in the atmosphere, the SPD ABL system (aircraft) does not need to travel deep within enemy territory to shoot down missiles in their boost phase.

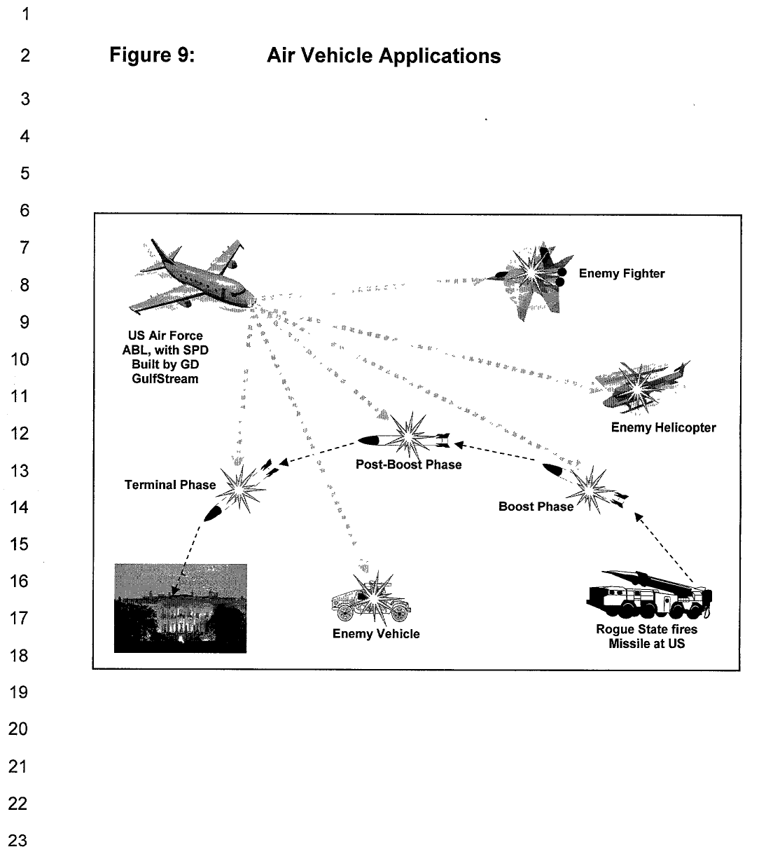

FIG. 10: Depicts the different application of SPD as a “Man-Portable Device”. The SPD laser system can be miniaturized to be made man-portable. The Compact Chemical Laser Cannon brings the power of Star Wars technology to the field. Providing heavy punch capabilities to the Special Operation Forces (SOF) at a relative low cost.

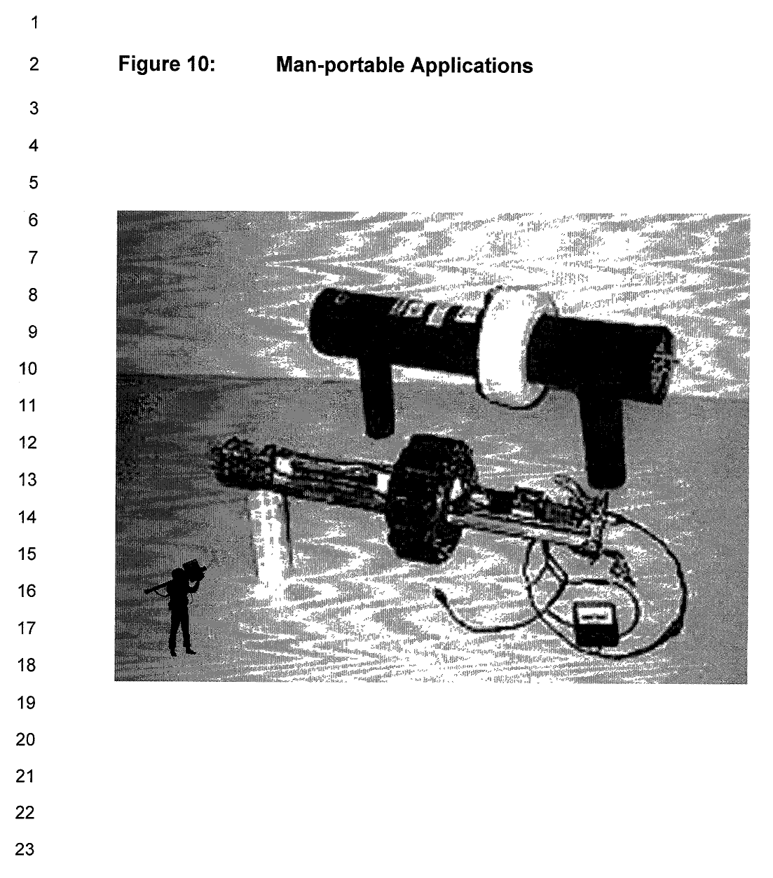

I claim:

1. It is another object, advantage, and feature of the invention that it uses 2 (two) synchronized laser pulses to create a Laser Supported Detonation Wave (LSDW) in a mixture of target vapors and atmospheric air.

2. It is another object, advantage, and feature of the invention that the first pulse of the SPD creates an ignition plasma spark in a mixture of air and target vapors.

3. It is another object, advantage, and feature of the invention that the second (higher powered) pulse of the SPD serves to create and support a shock wave from the heated plasma.

4. It is another object, advantage, and feature of the invention that the shock wave generated by the second laser pulse heats the surrounding air layer (mixture of air and target vapors) so that it begins to absorb the laser beam and to create from itself the next plasma layer with the formation of a new shock wave.

5. It is another object, advantage, and feature of the invention that the length of absorption of a laser beam in plasma near detonation threshold must equal the beam radius to achieve optimal threshold.

6. It is another object, advantage, and feature of the invention that since the heated plasma does not have time to expand in the LSDW, the pressure P_{LSD} in LSDW is:
P_{LSDW}>k*P_{ATMOSPHER}T_{LSDW}/T_{ATMOSPHER}>70*k*P_{ATMOSPHER},
Where k varies from 2.1 to 15 and even more depending on the atoms of the target material present in the dissociated air. So, P_{LSD} varies from 150 to 1000 atmospheres. If the laser beam focuses in the spot of diameter D or on the area S, the disturbance force F will be as follows:

| | |
|---|---|
| If D = 10 cm, then: | F = P_{LSD} * D² = from 15 to 100 Tons |
| If D = 1 m, then: | F = P_{LSD} * D² = from 1,500 to 10,000 Tons |
| If S = 1 m * 100 m, then: | F = P_{LSD} * D² = from 150,000 to |
| | 1,000,000 Tons |

7. It is another object, advantage, and feature of the invention that the several thousands of tons being generated by the SPD LSDW is more than enough to “shoot down” any object. If this force is not sufficient, the impulse force can be increased simply by increasing the vapor density (target material intensive vaporization).

8. It is another object, advantage, and feature of the invention that the SPD method is not restricted to distance, due to the fact that no continuing sharp focusing of the laser beam to the same area of the target is required.

9. It is another object, advantage, and feature of the invention that it can cause an object to spin simply by focusing the LSDW on a large area near either end of it; therefore, creating a large value of disturbance force on the object. This momentum can cause a spin and downward fall of the object, derailing it from its original course or trajectory

10. It is another object, advantage, and feature of the invention that it can cause an overload to any object simply by focusing the LSDW on the full surface of the object (such as a missile, aircraft, helicopter, and any other object). By doing so, this object will be exposed to overload of many thousands of “Gs” or even millions of “Gs”, if the first ignition beam creates a high enough pressure of vapors near the object. This overload will cause destruction to the object's infrastructure and the ignition of any onboard fuel.

11. It is another object, advantage, and feature of the invention that the size and weight of a laser system can be decreased by a hundred times without any decrease to the overload effect by decreasing the laser pulse duration accordingly.

12. It is another object, advantage, and feature of the invention that the initial vapors can be created at the top of an object by a more durable first pulse. Streamlined air would press this vapor layer to the object. So, the duration of the first laser pulse has to be equal to the object's length divided by the object's speed.

13. It is another object, advantage, and feature of the invention that the area of focus of the first laser beam has to be large enough in order to quickly provide enough vapors. Thus, going after vapors 1 mm inside the missile is optimal.

14. It is another object, advantage, and feature of the invention that the second (10-nanosecond) pulse creates LSDW in the vapor layer 1 (one) millisecond after the evaporation process begins.

15. It is another object, advantage, and feature of the invention that the Laser Supported Detonation Wave (LSDW) characteristics are determined by the following equations:
A. mass conservation:
ρu=ρ₀D
B. momentum conservation:
P+ρu²=P₀+ρ₀D²
C. energy conservation:
E+P/ρ+u²/2=E₀+P₀/ρ₀+D²/2
D. complete laser energy absorption at Chapman Jouguet Point:
E+P/ρ+u²/2=E₀+P₀/ρ₀+D²/2+I₀/(ρ₀D)
Where ρ is density, u is internal velocity, E is internal energy, D is wave velocity and P is pressure in Laser Supported Detonation Wave. The equation of state transformation from gaseous state to plasma state completes the set of equations

16. It is another object, advantage, and feature of the invention that if the threshold laser intensity is not more than 10⁸ Wt/cm² then the speed of LSDW at its threshold is not more than 2*10⁵ cm/sec (depending on the atomic mass of evaporated materials from missile or other target). So, for 1 microsecond (theoretically 10 nanoseconds is enough for LSDW formation) LSDW penetrates only several mm inside a missile, pushing it with maximum effectiveness. Therefore, the energy E needed to support this LSDW by a microsecond laser impulse is:
E<10⁸ Wt/cm²*10⁻⁶ sec=100 Joules/cm²
To support LSD (with beam diameter at a missile surface 100 cm²) only 10,000 Joules during microsecond impulse or 100 Joules during 10 nsec impulse is needed.

17. It is another object, advantage, and feature of the invention that the most stable and optimal proportions of chemicals used in SPD to achieve LSDW are as follows with a variance of ±30, pending the environment of the event:
F₂=4.00 or 38.46% by Volume
H₂=1.00 or 09.62% by Volume
O₂=0.40 or 03.85% by Volume
SF₆=5.00 or 48.08% by Volume

18. It is another object, advantage, and feature of the invention that the specific proportions of SF₆ in claim #17 makes the entire mixture inert to all other detonation or initiation methods (such as power light source) except that of an electrical discharge or electron accelerator. Making the chemical mixture safe to handle under most battle conditions.

19. It is another object, advantage, and feature of the invention that the firing process of SPD can be initiated by electron beams, with optimal repetition rate of pulses between 1-5 Hz, depending on the size of target and event environment.

20. It is another object, advantage, and feature of the invention that if a single laser impulse is not enough to destroy a target (a missile in this case) but only to cause its vibration, such a repetition gives us the opportunity to repeat laser impulses resonantly to the frequency of this vibration until complete destruction of any object.

21. It is another object, advantage, and feature of the invention that the LSDW generated by the SPD can be accomplished not only with chemical lasers but also by any other pulse lasers: for example, solid-state YAG-Nd lasers, CO₂-lasers, and etc.

22. It is another object, advantage, and feature of the invention that an electron beam methods can be used to initiate the chemical reaction in a laser volume. When operating the SPD, the electron beam accelerator with the following parameters can be used:
A) Maximum energy of the electrons:
500 keV
B) Maximum energy of the electron beam behind an anode foil:
6 kJ
C) Maximum current density on the anode:
25 A/cm
D) Beam cross-section on the anode:
200 mm×600 mm
E) Efficiency of the accelerator (ratio of electron beam energy to the energy stored in capacitors of a pulsed generator):
>60%
F) Pulse duration:
1 microsecond
G) Resource of operation (without changing the anode foil):
300 few hundred shots
H) Repetition rate of pulses:
1-5 Hz

23. It is another object, advantage, and feature of the invention that the SPD could use a cross-section electron beam or any other types of electron beam to initiate the chemical volume, as long as the electrons move perpendicular to the optical axis of the laser.

24. It is another object, advantage, and feature of the invention that the Synchronized Photo-pulse Detonation (SPD) method is such a versatile technology, not only is it capable of improving the kill-ratio and the time needed for Laser Supported Detonation (LSD) of hostile targets, it can also be deployed on any current and future firing platforms.

25. It is another object, advantage, and feature of the invention that the SPD system can be deployed aboard satellites or any future space vehicles for the express purpose of Space-to-Space (STS), Space-to-Air (STA), and Space-to-Ground (STG) target engagements.

26. It is another object, advantage, and feature of the invention that the SPD system can be deployed for use under water to the following rolls, but is not limited to the following: both anti-shipping and anti-shipping rolls.

27. It is another object, advantage, and feature of the invention that the underwater version of the SPD, could use a specific wavelength of 1,06 μm, or any other wavelength which is transparent in both the air and water medium, and be deployed on any underwater or surface firing platform against both surface and underwater targets.

28. It is another object, advantage, and feature of the invention that the SPD could be deployed on aboard any ground vehicles and be used against any ground or air target and be used as an automated perimeter century system.

29. It is another object, advantage, and feature of the invention that SPD can be deployed aboard most air vehicles (such as a GD Gulfstream aircraft).

30. It is another object, advantage, and feature of the invention that the SPD laser system can be miniaturized to be made man-portable.
